(19) United States
(12) Patent Application Publication
(10) Pub. No.: US 2002/0167967 A1
(43) Pub. Date: Nov. 14, 2002

(54) Method for managing bandwidth on an ethernet network

(75) Inventors: Francois Jammes, Chamrousse (FR); Jacques Camerini, Grasse (FR); Julien Lagier, Grenoble (FR)

Correspondence Address: SQUARE D COMPANY, INTELLECTUAL PROPERTY DEPARTMENT, 1415 SOUTH ROSELLE ROAD, PALATINE, IL, 60067, US

(73) Assignee: Schneider Electric, Palatine, IL

(21) Appl. No.: 10/063,242

(22) Filed: Apr. 2, 2002

Related U.S. Application Data
(63) Continuation-in-part of application No. 09/623,689, filed on Sep. 6, 2000.

(51) Int. Cl. H04J 3/16

(52) U.S. Cl. 370/468; 370/431

(57) ABSTRACT

A method for constructing a bandwidth configuration to facilitate communication among a plurality of operably connected devices on an Ethernet network. Each network device having communication capabilities including a CPU for processing one or more communication services. Communication services are derived from an application requirement to be executed throughout the network. The communication services to be processed by each device are identified. A share of CPU capacity required for processing the communication services is identified and apportioned among all the communication services in accordance with the application requirement.

### CROSS REFERENCE TO RELATED APPLICATIONS

This patent application is being filed concurrently with commonly assigned U.S. Patent Application entitled, “Method And Apparatus For Ethernet Prioritized Device Clock Synchronization,” Serial No. ##/###,###, filed Apr. 1, 2002 (Attorney Docket No. SAA-79 (401 P 272)); the content of which is expressly incorporated herein by reference. This patent application is related to U.S. Pat. No. 6,223,626 entitled “SYSTEM FOR A MODULAR TERMINAL INPUT/OUTPUT INTERFACE FOR COOMUNICATING MESSAGE APPLICATION LAYER OVER ETHERNET TO TRANSPORT LAYER;” the content of which is expressly incorporated herein by reference. This patent application is related to and claims priority to U.S. Patent Application entitled “COMMUNICATION SYSTEM FOR A CONTROL SYSTEM OVER ETHERNET AND IP NETWORKS,” Ser. No. 09/623,869, filed Sep. 6, 2000 (Attorney Docket No SAA-9); the content of which is expressly incorporated herein by reference.

### Background of Invention

1. Technical Field

The present invention relates generally to networks and more specifically, to managing bandwidth of and Ethernet network.

2. Background of the Invention

Ethernet is utilized today in real-time applications to connect devices, i.e., programmable logic controllers (PLCs), personal computers (PCs), Input/Output (IO) devices, drives, human-machine interfaces (HMIs), circuit breakers, etc. Real time data such as IO values, statuses, commands, etc., are simultaneously exchanged over the Ethernet network with non-real-time communication traffic such as network management, web data, video information, etc. Ethernet is a shared media with rules for sending packets of data. These rules protect data integrity and avoid conflicts. Nodes determine when a network allows packets to be sent. Motor control, drives, robots, factory automation, and electrical distribution are just a few of the potential applications for industrial controls linked with Ethernet.

In these implementations, Ethernet fails to provide a deterministic data exchange having the capability to ensure an exchange of data within a given time period. This non-deterministic aspect of Ethernet and the openness of TCP/IP can induce difference latency and jitter in the performance of communication services. In industrial control applications, it is possible for two nodes at different locations to send data concurrently. When both devices transfer a packet to the network concurrently, a collision will result.

Minimizing these collisions in factory automation applications is a critical portion of the design and operation of their networks. An increase of collisions in industrial control environments is frequently caused by increases of control-system devices on the network. This creates contention for network bandwidth and slows network performance.

The Institute for Electrical and Electronic Engineers Society (IEEE) defines an Ethernet Standard IEEE802 for establishing an Ethernet network configuration guideline and specifying how elements of an Ethernet network interact. Network equipment and protocols can efficiently communicate when adhering to this IEEE standard.

Network protocols are standards that facilitate communication among operably connected devices. One protocol may define how network devices identify one another while another protocol may define the format of the transmitted data and how the data gets processed once it reaches its destination. Additional protocols such as transmission control protocol/internet protocol (TCP/IP) (for UNIX, Windows NT, Windows 95 and other platforms) define procedures for handling lost or damaged transmissions or “packets”.

Quality of service in the TCP/IP is comprised of five layers, i.e. application, transport, network, data, and physical layers. The application layer relates to application and user access, authorization, and encryption. The transport layer involves TCP rate control and port access control. The network layer includes load balance, resource reserves, service bit types, and path controls. The data link layer entails IEEE802.1p/Q frame prioritization as well as logical port access control. And finally, the physical layer is addressed to bit error correction, physical security and port access.

Network quality of service is important for proper and predictable industrial control system performance. There are a number of factors that may diminish network performance. The first is delay—which is the time a packet takes to go from the sender to the receiver device via the network. Long delays put greater stress on the transport protocol to operate efficiently, particularly motion control, drives and robots applications. Long delays imply large amounts of network data held in transit. Delays affect counters and timers associated with the protocol. In the TCP protocol, the sender's transmission speed is modified to mirror the flow of signal traffic returning from the receiver, via the reply acknowledgments (ACK's) that verify a proper reception. Large delays from senders and receivers make the feedback loop insensitive. Delays result in the protocol becoming insensitive to dramatic short-term differences in industrial control system network load. Delays affecting interactive voice and video applications cause systems to appear unresponsive.

Jitter is another network transit delay. Large amounts of jitter cause the TCP protocol to conservatively estimate the round trip message time. This creates inefficient factory automation protocol operation by requiring timeouts to reestablish the flow of data. A large quantity of jitter in user datagram protocol (UDP) based real time applications such as an audio or video signal is intolerable. Jitter creates distortion in the signal, which then must be cured by enlarging the receiver's reassembly playback queue. The longer queue delays the signal, making interactive communication difficult to maintain, detrimentally for factory automation.

A third network issue is its bandwidth, the maximal industrial control data transfer rate. Bandwidth may be restricted by other traffic that shares common elements of the route as well as the physical infrastructure limitations of the traffic path within the factory automation transit network.

### SUMMARY OF INVENTION

One embodiment of the present invention is directed to a method for constructing a bandwidth configuration to facilitate communication among a plurality of operably connected devices on an Ethernet network. Each network device has communication capabilities that include a CPU for processing one or more communication services. The communication services are derived from a requirement for executing an application on the network. The communication services to be processed by the device are identified and a share of the device's CPU capacity required for processing the communication services is determined. The CPU capacity is apportioned among all the communication services in accordance with the application requirement.

Another embodiment of the present invention is directed to an Ethernet communication network having a plurality of devices being responsive to an application. Each device has a CPU for processing one or more communication services. A method for constructing a bandwidth configuration to facilitate communication among the devices includes determining a bandwidth requirement. The bandwidth requirement is derived from the application. A bandwidth configuration is created in response to the bandwidth requirement. The bandwidth configuration is verified and the actual bandwidth usage is monitored.

Yet another embodiment of the present invention is directed to an Ethernet communication network executing an application. The network has a plurality of nodes including operably connected devices. Each device has communication capabilities including a CPU for processing one or more communication services required by the application. A method for facilitating communication throughout the network includes determining a bandwidth configuration for each device supporting the communication services. Consistency of the bandwidth configuration throughout each node supporting the application is ensured wherein various classes of services are utilized at all communication layers of the network for maintaining a consistent management of bandwidth.

The management of network traffic enables predictable performance for critical application traffic. Thus, one object of the present invention is to facilitate bandwidth management of an Ethernet network.

Another object of the present invention to provide a mechanism for enabling predictable performance of a distributed application throughout an Ethernet network.

Other features and advantages of the present invention will be apparent from the following specification taken in conjunction with the following drawings.

### BRIEF DESCRIPTION OF DRAWINGS

FIG. 1 is a simplified block diagram listing different functions of bandwidth management;

FIG. 2 is a simplified state chart depicting various states of bandwidth management;

FIG. 3 is a simplified block diagram of an exemplary bandwidth configuration;

FIG. 4 is a table depicting various examples of bandwidth profiles;

FIG. 5 is a listing of various classes of network traffic; and,

FIG. 6 is a listing of various classes of network services.

### DETAILED DESCRIPTION

While this invention is susceptible of embodiments in many different forms, there is shown in the drawings and will herein be described in detail a preferred embodiment of the present invention with the understanding that the present disclosure is to be considered as an exemplification of the principles of the invention and is not intended to limit the broad aspect of the present invention to the embodiment illustrated.

Ethernet's general lack of message prioritization and the openness of the TCP/IP protocol may introduce latent performance flaws relating to network traffic. Industrial control network traffic bursts can result in message losses and slow responses caused by non-critical network traffic. Categorizing traffic may be implemented to ensure that critical factory automation traffic will always flow despite the demands of less important applications. The prioritization of industrial control network traffic enables predictable performance for the most critical application traffic.

Quality of service mechanisms can be incorporated at any or all of the five layers of the TCP/IP stack and the positioning of the key quality of service mechanisms. Some of these mechanisms are inherent in the protocols rather than being explicitly added for quality of service control. The quality of service characteristics of an industrial control network can be managed using mechanisms operating at the edge of the network or within its core. Quality of service may be controlled by reserving a fixed amount of bandwidth for critical applications or preventing specific users from accessing restricted data like WWW destinations. Additional quality of service controls include: assigning higher priority to traffic to and from specific customers, limiting the bandwidth that can be consumed by voice over IP traffic, or designating specific types of traffic that may be dropped during increased traffic congestion. End-to-end solutions include regulating individual traffic flow, processing quality of service information within the network, and monitoring the bandwidth configuration of the network.

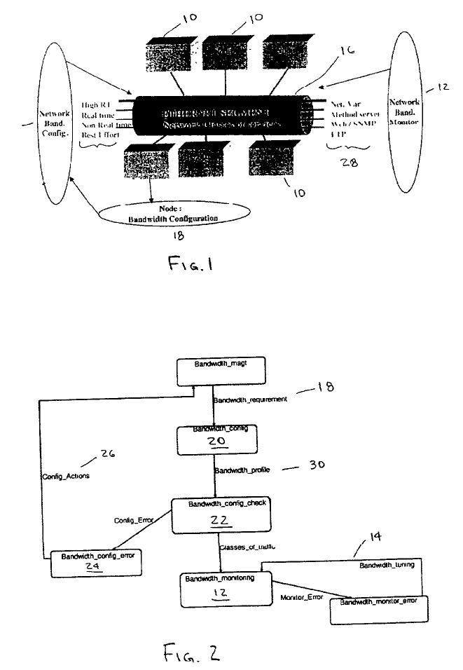

To ensure optimum performance of an Ethernet network, bandwidth management should be taken into account during the different phases, i.e., design, installation, etc., of a distributed application. Several functions must be addressed at build time of the network. These functions include: bandwidth configuration in every node 10, bandwidth monitoring 12, bandwidth tuning 14, and the use of network classes of services 16. See FIG. 1.

The following steps are offered as a general guideline that can be followed to obtain complete bandwidth management within a distributed application: (1) a bandwidth configuration should be determined in each device following the communication services requirement; (2) a consistent bandwidth configuration should be done within all nodes of an application in conformance with the distributed application requirement; (3) network classes of services can be utilized to ensure consistent bandwidth management at all layers of the communication system; and, (4) various network topologies can be implemented to facilitate the management of the network traffic.

During build time of the distributed application, the bandwidth configuration is constructed. FIG. 2 depicts a state chart summarizing the various states of the bandwidth management. The bandwidth configuration requirement 18 is derived from the application to be executed. A bandwidth profile 30 may further affect the bandwidth configuration 20. The bandwidth configuration 20 is checked 22 to ensure the requirements have been satisfied. Unsatisfactory configurations result in an error signal 24 wherein further corrective adjustments 26 to the configuration bandwidth are implemented. A satisfactory bandwidth configuration 20 is monitored 12 during run-time of the application. The bandwidth configuration 20 can be tuned 14 in response to errors occurring during execution of the application.

The distributed application requires some communication capabilities to process its functions. Each device part of an application has to provide communication capacities to process the number of network variables, the number of messages, and other communication services required by the application. The communication capabilities of an application are typically measured with respect to time, i.e., number of messages per second, number of publication per second, number of subscriptions per second, etc.

Every node/device 10 provides predetermined capabilities to process a number of communication services 28 at full, dedicated capacity. Some capabilities include: N publish/subscribe per second of the network variable services; M transactions per second of the method server service; X reception and emission of event per second; and, Y non-real-time transactions per second (SNMP, FTP, Web).

The CPU power must be shared between all communication services 28 in accordance with the application requirement. One aim of the bandwidth configuration 20 is to determine how the CPU load of a device is apportioned to process all required communication services 28 to manage the distributed application. The bandwidth configuration 20 is checked 22 to verify the feasibility of these requirements. The end result of the bandwidth configuration 20 cannot require more than 100% of the device's CPU capabilities. The data used to determine the bandwidth configuration 20 can be determined automatically from the application configuration or can be obtained through a user interface.

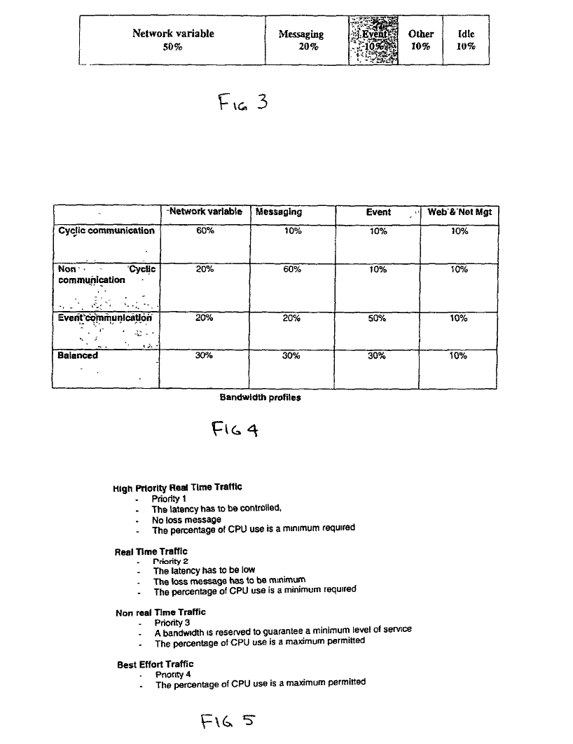

For example, a device, Al, provides the following communication capabilities: 1000publish/subscribe per second of the network variable services; 500 transactions per second of the method server service; 1000 reception and emission of event per second; and, 500 non-real-time transactions per second (SNMP, FTP, Web). These communication capabilities are determined when the CPU of Al is wholly dedicated to process a single communication service 28. If Al is used in a distributed application that requires the processing of the following communication services: 500 publish/subscribe per second of the network variable services; 100 transactions per second of the messaging service; 100 reception and emission of event per sec; and, 50 non-real-time transactions per second (SNMP, FTP, Web), the bandwidth configuration determined in accordance with these application requirements will be: Network Variable 50%; Messaging 20%; Event 10%; Other 10%; and Idle 10%. FIG. 3. These required communication services are identified and derived from the distributed application.

The resulting bandwidth configuration 20 shows that not all the device CPU capacity is utilized; therefore, validation can be done. Nevertheless, it is important to mention that if in the previous example the application would require more publish/subscribe exchanges, e.g., 800, a configuration error would occur. In this case, the correct actions 26 are initiated to reduce the communication requirements.

The above bandwidth configuration example was executed without any constraint limiting the sharing of the CPU capacity—other than the requirements of the distributed application. A bandwidth profile 30 can be used to further constrain the apportionment of the CPU capacity and to later verify whether the bandwidth configuration satisfies the requirements of the profile. FIG. 4 illustrates some examples of bandwidth profiles. The above example did not involve a bandwidth profile 30. In the case where a bandwidth profile 30 is provided, i.e., cyclic communication, the bandwidth configuration 20, i.e., network messaging, must be modified to be compliant. The bandwidth profile 30 initially sets a boundary of each communication service. Afterwards, the profile 30 assists a more accurate bandwidth configuration check 22.

Bandwidth monitoring 12 is done during run-time of the application. The purpose of the monitoring is to verify and guarantee the bandwidth configuration 20 defined during the build time. The verification of the bandwidth configuration requires some calculation within the communication layer, e.g., number of method requests, number of publication, etc. When the measured value of the bandwidth exceeds the configured value, a corrective action needs to be applied, e.g., queuing the request, reducing communication services, assigning a priority level to every type of communication service, etc.

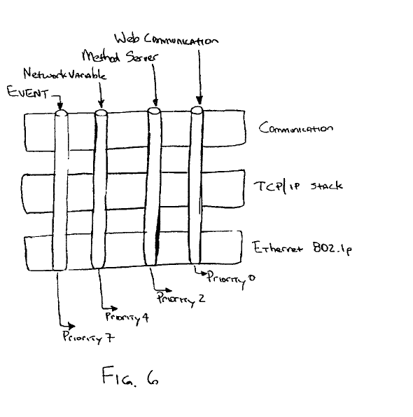

To further facilitate bandwidth configuration, a priority level can be assigned to the different tasks dedicated to each communication service. Classes of network traffic are defined to determine a level of priority and a resulting action to be taken when conflicts occur. During the configuration phase, a class of traffic can be assigned to each type of communication service. There are four categories of network traffic: high priority real-time traffic; real-time traffic, non-real-time traffic; and best effort traffic. FIG. 5 depicts the attributes each of these four classes of network traffic. Using these classes of network traffic, a device can manage the different communication services to guarantee the bandwidth configuration. Using the previous example of the Al device, if the number of method server transactions exceed 100, the surplus is lost when non-real-time traffic is assigned to it or the communication service is queued when real-time traffic is assigned. A status error is set in the bandwidth management status object, a tuning action and diagnostic tool (SNMP manager) can be utilized to fix the problem.

The bandwidth management is fully operational when the different classes of services are managed at all layers of the communication system: communication level, TCP-IP stack, Ethernet layer 2. The use of priorities (IEEE802.1p Standard) allows the management of all devices having the same classes of traffic with the same priority. IEEE802.1p also allows for the reduction of real-time traffic jitter. Of the 8 priority levels defined in IEEE802.1p, four priority levels are used: Priority 7 : High Real Time traffic, Priority 4 : Real-time traffic, Priority 2 : Non-real-time traffic; Priority 0. FIG. 6.

IEEE802.1p Standard defines how network frames are tagged with user priority levels ranging from 7 highest to 0 lowest priority. IEEE802.1p compliant network infrastructure devices, such as switches and routers, prioritize network traffic delivery according to the user priority tag. Higher priority tagged frames are given precedence over lower priority or non-tagged frames. Thus, time critical data receives preferential treatment over data that is not considered time critical.

Potential applications using the preferred embodiment of the present invention include motion control, drives and robots application requiring fast synchronization, electrical distribution applications requiring discrimination of events, automation applications with Ethernet bandwidth management issues, applications requiring voice, data, and image coexisting on the same Ethernet network, and the like.

While the specific embodiments have been illustrated and described, numerous modifications come to mind without significantly departing from the spirit of the invention, and the scope of protection is only limited by the scope of the accompanying Claims.

We claim:

1. A method for constructing a bandwidth configuration to facilitate communication among a plurality of operably connected devices on an Ethernet network, each device having communication capabilities including a CPU for processing one or more communication services, the method comprising the steps of:
identifying the communication services to be processed by the device, the communication services being derived from an application requirement;
determining a share of CPU capacity required for processing the communication services; and,
apportioning the CPU capacity among all the communication services in accordance with the application requirement.

2. The method of claim 1 further comprising the steps of:
checking the apportionment of the bandwidth configuration; and,
determining whether the cumulative amount of CPU capacity required for processing the communication services does not exceed the communication capabilities of the CPU.

3. The method of claim 2 further comprising the step of:
modifying the communication services in response to the communication services exceeding the communication capabilities of the CPU.

4. The method of claim 3 further comprising the step of:
monitoring the bandwidth usage of the network; and,
initiating a corrective action to circumvent network communication problems arising from the bandwidth configuration being exceeded.

5. The method of claim 4 wherein monitoring the bandwidth usage further comprises the steps of:
measuring the actual bandwidth usage:
comparing the measured bandwidth usage with the bandwidth configuration; and,
transmitting a bandwidth monitor error signal.

6. The method of claim 4 wherein initiating a corrective action further comprises the step of:
assigning a priority level to every type of communication service.

7. The method of claim 6 further comprising the step of:
utilizing IEEE802.1p Standard in cooperation with assigning a priority level to every type of communication service.

8. The method of claim 1 further comprising the step of:
providing a bandwidth configuration profile for constraining the apportioning of the CPU capacity among the communication services.

9. For an Ethernet communication network having a plurality of devices being responsive to an application, each device including a CPU for processing one or more communication services, a method for constructing a bandwidth configuration to facilitate communication among the devices, the method comprising the steps of:
identifying a bandwidth requirement, the bandwidth requirement being derived from the application;
creating the bandwidth configuration in response to the bandwidth requirement;
verifying the bandwidth configuration; and,
monitoring the actual utilization of the bandwidth.

10. The method of claim 9 wherein determining a bandwidth requirement comprises the steps of:
identifying the communication services required by the application; and,
determining the communication capabilities required by the communication services.

11. The method of claim 10 wherein creating the bandwidth configuration in response to the bandwidth requirement comprises the steps of:
determining the CPU capacity required for processing the identified communication services;
apportioning the CPU capacity among all the communication services in accordance with the application and the communication capabilities of the device.

12. The method of claim 9 wherein verifying the bandwidth configuration includes the steps of:
comparing the apportioned CPU capacity to the bandwidth requirement derived from the application; and,
adjusting the bandwidth configuration in accordance with the application and the communication services.

13. The method of claim 9 wherein monitoring the bandwidth configuration includes the steps of:
measuring the bandwidth usage;
determining whether the configuration bandwidth is being exceeded; and,
initiating a corrective action in the event that the configuration bandwidth is being exceeded, the corrective action being responsive to the type of communication service being affected.

14. The method of claim 13 wherein initiating a corrective action includes:
assigning a priority level to each communication service wherein network traffic categories consistent with IEEE802.p Standard are utilized to facilitate communication throughout the network.

15. The method of claim 11 further including utilizing a bandwidth configuration profile for constraining the apportioning of the CPU capacity among the communication services.

16. For an Ethernet communication network executing an application, the network including a plurality of nodes having operably connected devices, each device having communication capabilities including a CPU for processing one or more communication services required by the application, a method for facilitating communication throughout the network comprising the steps of:
determining a bandwidth configuration for each device supporting the communication services;
ensuring consistency of bandwidth configuration throughout each node supporting the application;
utilizing classes of services at all communication layers of the network for maintaining a consistent management of bandwidth.

17. The method of claim 16 further comprising the steps of:
identifying the communication services to be processed by the devices, the communication services being derived from the application requirement;
determining a share of CPU capacity required for processing the communication services; and,
apportioning the CPU capacity among all the communication services in accordance with the application requirement.

18. The method of claim 17 further comprising the steps of:
checking the apportionment of the bandwidth configuration; and,
determining whether the cumulative amount of CPU capacity required for processing the communication services exceeds the communication capabilities of the CPU.

19. The method of claim 18 further comprising the step of:
reducing the communication services in response to the communication services exceeding the communication capabilities of the CPU.

20. The method of claim 17 further comprising the step of:
monitoring the bandwidth usage of the network;
initiating a corrective action to curtail network communication problems arising from the bandwidth configuration being exceeded.

21. The method of claim 20 wherein monitoring the bandwidth usage further comprises the steps of:
measuring the actual bandwidth usage:
comparing the measured bandwidth usage with the bandwidth configuration; and,
transmitting a bandwidth monitor error signal.

22. The method of claim 20 wherein initiating a corrective action further comprises the step of:
assigning a priority level to every type of communication service.

23. The method of claim 22 further comprising the step of:
utilizing IEEE802.1p Standard in cooperation with assigning a priority level to every type of communication service.

24. The method of claim 17 further comprising the step of:
providing a bandwidth configuration profile for constraining the apportioning of the CPU capacity among the communication services.
